(19) United States
(12) Patent Application Publication
(10) Pub. No.: US 2013/0077760 A1
(43) Pub. Date: Mar. 28, 2013

(54) RADIATION IMAGING APPARATUS AND DETACHABLE GRID UNIT FOR SAME

(71) Applicant: Motoki Tagawa, Chigasaki-shi (JP)

(72) Inventor: Motoki Tagawa, Chigasaki-shi (JP)

(73) Assignee: CANON KABUSHIKI KAISHA, Tokyo (JP)

(21) Appl. No.: 13/609,919

(22) Filed: Sep. 11, 2012

(30) Foreign Application Priority Data
Sep. 27, 2011 (JP) 2011-211127

(51) Int. Cl. G21K 1/00

(52) U.S. Cl. 378/154

(57) ABSTRACT

A radiation imaging apparatus includes a radiation detector, and a grid unit configured to be combined with the radiation detector. The radiation detector includes a radiation sensor configured to convert incident radiation into an electrical signal to obtain an image, a casing configured to accommodate the radiation sensor, and a first gripping portion formed on the casing. The grid unit includes a grid, a combining portion configured to combine the grid unit with the radiation detector, and a second gripping portion configured to form a gripping portion together with the first gripping portion of the radiation detector in a state where the grid unit is combined with the radiation detector.

### BACKGROUND

### Technical Field

Digital X-ray detectors, unlike conventional X-ray films and computed radiography (CR) imaging plates, require no development processing and thus have an advantage in that an image can be immediately observed after imaging. However, digital X-ray detectors have higher weights and larger sizes because these include digital image sensors and electric circuits enclosed in a casing. Thus, maneuvering (for portability and positioning) of these digital X-ray detectors tends to be complicated. Japanese Patent No. 3577003 discusses a technique for providing a gripping portion on a digital X-ray detector for improved portability.

In conventional imaging, when X-rays scattered by an object have a high impact, an anti-scatter grid (hereinafter, referred to as a grid) has been used for anti-scatter purposes. The grids can improve the contract of X-ray images. For upright imaging, a grid and an X-ray detector are mounted on a dedicated pedestal to perform imaging. In imaging in a hospital ward, a grid is attached to an X-ray detector as discussed in Japanese Patent Application Laid-Open No. 2010-243264 to perform imaging.

Suppose that a digital X-ray detector including a gripping portion is to be mounted on a pedestal. The gripping portion needs to be small to allow a wide imaging area, in which case the gripping portion can only provide low portability and operability. If a grid is attached to the digital X-ray detector, the increased weight further deteriorates the portability.

### SUMMARY

According to some embodiments of the present invention, a radiation imaging apparatus includes a radiation detector configured to be mountable on a pedestal, and a grid unit configured to be used with the radiation detector not mounted on the pedestal, wherein the radiation detector includes a radiation sensor configured to convert incident radiation into an electrical signal to obtain an image, a casing configured to accommodate the radiation sensor, and a first gripping portion formed on the casing, and wherein the grid unit includes a grid, a combining portion configured to combine the grid unit with the radiation detector, and a second gripping portion configured to form a gripping portion together with the first gripping portion of the radiation detector in a state where the grid unit is combined with the radiation detector. The second gripping portion has a size greater than or equal to a size of the first gripping portion.

Further features and aspects of the present disclosure will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the embodiments of the present invention.

FIG. 1A is a front view of an X-ray detector according to an exemplary embodiment. FIG. 1B is a cross-sectional view of the X-ray detector.

FIG. 2A illustrates the X-ray detector mounted on a flat-bed pedestal. FIG. 2B illustrates the flat-bed pedestal viewing from directly above.

FIG. 3 is a front view of a grid unit according to the exemplary embodiment.

FIG. 4 illustrates a combining operation for placing the X-ray detector and the grid unit in a combined state, according to the exemplary embodiment.

FIG. 5A illustrates the X-ray detector with the grid unit attached thereto according to the exemplary embodiment.

FIG. 5B is a cross-sectional view of the X-ray detector and the attached grid unit.

FIG. 6 illustrates a lock mechanism for attaching and detaching the grid unit.

FIG. 7 illustrates states in which the X-ray detector is mounted on a pedestal according to another exemplary embodiment.

FIG. 8 illustrates a state in which a grid unit is attached to an X-ray detector according to another exemplary embodiment.

### DESCRIPTION OF THE EMBODIMENTS

Various exemplary embodiments of the present invention will be described in detail below with reference to the drawings.

A radiation imaging apparatus according to an exemplary embodiment of the present invention is described below. The radiation imaging apparatus includes a radiation detector and a grid unit. The radiation detector may be used for imaging either mounted on a pedestal or not mounted on a pedestal. The grid unit is detachably combined with the radiation detector when the detector is used for imaging not mounted on the pedestal.

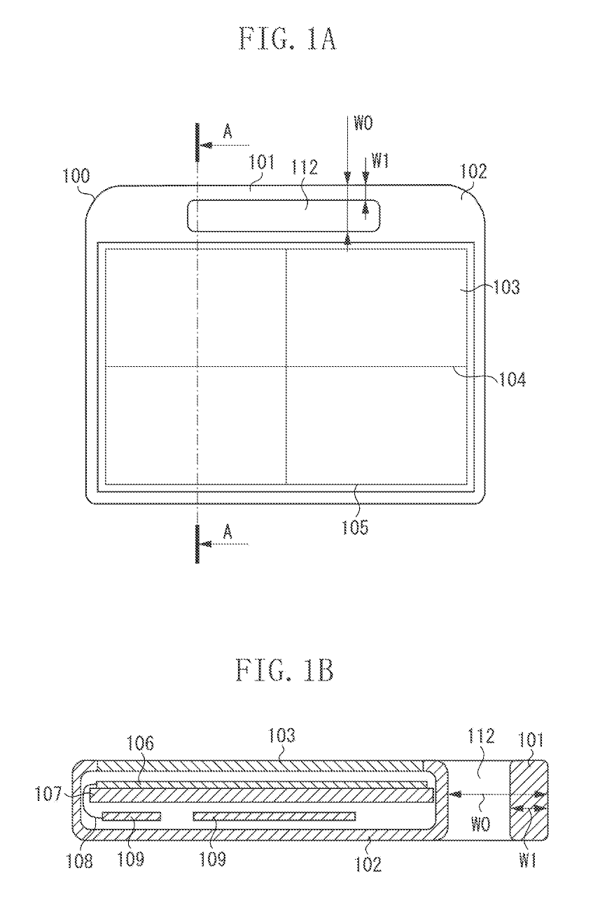

FIGS. 1A and 1B illustrate a portable X-ray detector 100 according to the present exemplary embodiment. FIG. 1A is a front view of the X-ray detector 100 as seen from an radiation incident surface side. FIG. 1B is a cross-sectional view taken along line A-A in FIG. 1A.

When an X-ray image is captured, a subject to be imaged is placed between an X-ray generation apparatus (not illustrated) and the X-ray detector 100. The X-ray detector 100 reads X-rays transmitted through the subject to be imaged to acquire image information. During an imaging operation, a subject may sit directly on the X-ray detector 100. The X-ray detector 100 may be accidentally bumped against something or dropped during transportation. The X-ray detector 100 therefore needs to have sufficient mechanical strength to withstand the weight of a subject and/or eventual mishandling incidents. Preferably, however, the X-ray detector 100 needs to have a light weight to reduce transportation burdens. To that end, materials such as aluminum and magnesium are therefore suitably used for a protective casing 102 of the X-ray detector 100.

FIG. 1B illustrates the manner in which the casing 102 accommodates therein an X-ray sensor panel 106 (X-ray sensor) which converts incident X-ray radiation into electrical signals to obtain an X-ray image. The X-ray sensor panel 106 includes a glass substrate on which photoelectric conversion elements and a phosphorous material are laminated. X-rays with which the X-ray sensor panel 106 is irradiated make the phosphorous material emit light. The photoelectric conversion elements convert the light into electrical signals to obtain an image signal. The X-ray sensor panel 106 is connected to an electrical circuit board 109 via a flexible circuit board 108. The electrical circuit board 109 includes a drive circuit, an analog amplifier, an analog-to-digital (A/D) converter, and other electronic components known to persons of ordinary skill in the art. The electrical circuit board 109 controls the X-ray sensor panel 106 and processes the image signal.

The X-ray sensor panel 106 and the electrical circuit board 109 are fixed to a rigid base 107 to prevent deformation and cracking under an external load, or to prevent vibrations during transportation and maneuvering. The X-ray sensor panel 106, the electrical circuit board 109, and the base 107 are accommodated in the casing 102. If a metal casing 102 lies on the X-ray incident surface side of the X-ray sensor panel 106, a high quality image cannot be obtained due to absorption of incident X-rays. Accordingly, an X-ray transparent plate 103 made of carbon-fiber-reinforced plastics (CFRP) or the like is arranged on the X-ray incident surface side of the X-ray sensor panel 106. As shown in FIG. 1A, the X-ray transparent plate 103 is marked with indexes 104 and 105 which respectively indicate a reading center and a reading range limit (edge) of the X-ray sensor panel 106.

As illustrated in FIGS. 1A and 1B, the X-ray detector 100 includes a gripping portion (first gripping portion) 101 and an opening 112 for handling the detector. The gripping portion 101 and opening portion 112 are part of the casing 102. An operator can carry the X-ray detector 100 by gripping the gripping portion 101; this allows improved operability and ease of handling the detector. However, by providing the gripping portion 101, an external size of the detector is increased, and the gripping portion 101 may interfere with handling and positioning operations when the X-ray detector 100 is loaded into various types of pedestals such as an upright stand for chest imaging and a recumbent imaging stand. The opening 112 and the gripping portion 101 are thus limited to have a small width W0.

If the opening 112 has too small a width to put fingers through, the X-ray detector 100 cannot be carried by gripping the gripping portion 101. To protect a radiological technologist from radiation exposure during X-ray imaging, the radiological technologist may grip the X-may detector 100 with protective gloves on. The opening 112 needs to let the fingers through even in such situations. The protective gloves generally contain an adequate amount of lead to provide X-ray protection and thus are large in size. The opening 112 therefore needs to have a sufficiently large width. To maintain a minimum adequacy of width W0 and provide an X-ray detector 100 that can be loaded into various types of pedestals, the width W1 of the gripping portion 101 needs to be made smaller.

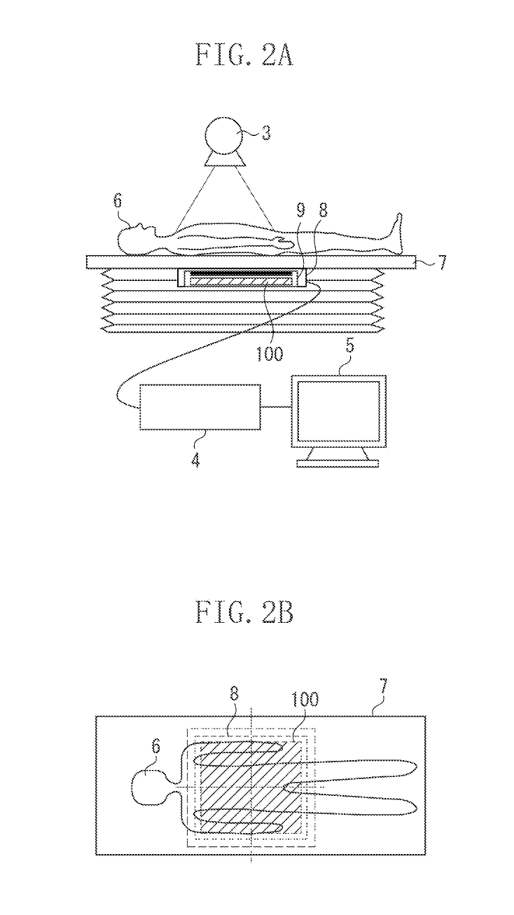

Referring to FIGS. 2A and 2B, a case will be described in which the X-ray detector 100 is mounted on a pedestal. FIG. 2A illustrates the X-ray detector 100 mounted on a flat-bed pedestal as seen from a side. FIG. 2B illustrates the pedestal in FIG. 2A as seen in the X-ray incident direction.

As illustrated in FIGS. 2A and 2B, an object (subject) 6 is situated on a pedestal 7. An accommodation unit 8 for the X-ray detector 100 is arranged under the pedestal 7. The accommodation unit 8 is configured to be able to accommodate and hold the X-ray detector 100. When the portable X-ray detector 100 is used in a radiation room for X-ray imaging, a pedestal corresponding to a desired imaging mode is prepared. Loading the X-ray detector 100 into the pedestal facilitates positioning with respect to the object 6. Examples of the pedestal include an upright stand for chest imaging, as well as the recumbent imaging stand like the present exemplary embodiment. A conventional film cassette, or a modified grid cabinet, may be used as the accommodation unit in the pedestal 7, depending on the size of the X-ray detector 100.

The accommodation unit 8 functions as a detector holding unit that accommodates and holds the X-ray detector 100. Conventionally, the accommodation unit 8 also functions as a grid holding unit that accommodates and holds an anti-scattering grid (hereinafter, referred to as a grid) 9. The accommodation unit 8 accommodates and holds the X-ray detector 100 and the grid 9 so that X-ray detector 100 and the grid 9 are mounted on the pedestal 7.

If the grid 9 is a convergence grid, the grid 9 is arranged so that an X-ray focus of an X-ray generation apparatus 3 coincides with a focus of the mounted grid 9. The grid 9 is generally arranged so that the center of the X-ray detector 100 coincides with that of the grid 9 when seen from the X-ray focus.

The X-ray detector 100 is detachably attached to the pedestal 7 by being inserted and removed into/from the accommodation unit 8. The grid 9 may similarly be detachably attached to the pedestal 7.

There is a plurality of grids 9 with different characteristics including grid densities, focusing distances, and grid ratios. A grid 9 having appropriate characteristics is selected according to an imaging target and diagnostic use. The grid 9 may be fixed to the pedestal 7 instead of being capable of insertion and removal. Imaging targets with less X-ray scattering, such as bones of extremities and an infant, may be imaged without the grid 9.

The grid 9 need not be constantly attached throughout imaging. For example, regions with relatively small scattered radiations such as bones of the extremities may be imaged with the grid 9 detached.

As illustrated in FIG. 2B, the object 6 or the X-ray detector 100 and the grid 9 are moved and fixed so that the X-ray detector 100 and the grid 9 accommodated in the pedestal 7 come to more appropriate positions, then imaging is started.

An image processing unit 4 applies predetermined image processing to an X-ray image that is based on electronic signals obtained by the X-ray detector 100 receiving X-rays. Examples of the predetermined image processing include offset correction, gain correction, defective pixel correction, gradation conversion processing, and dynamic range compression processing. The image-processed X-ray image is displayed on a display unit 5.

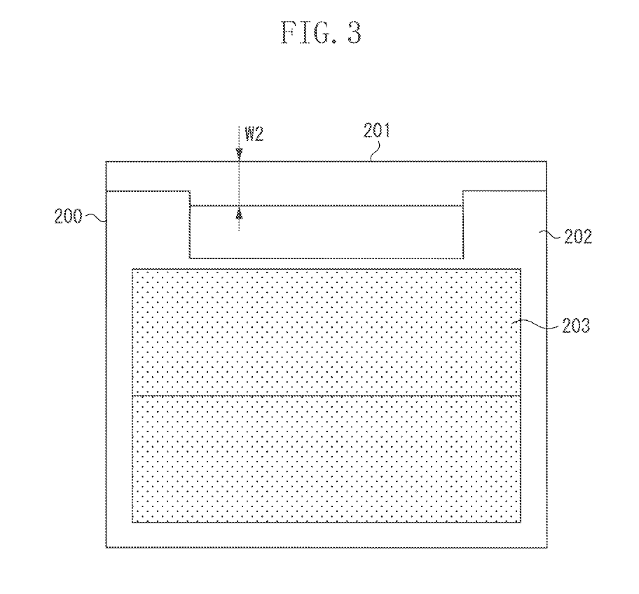

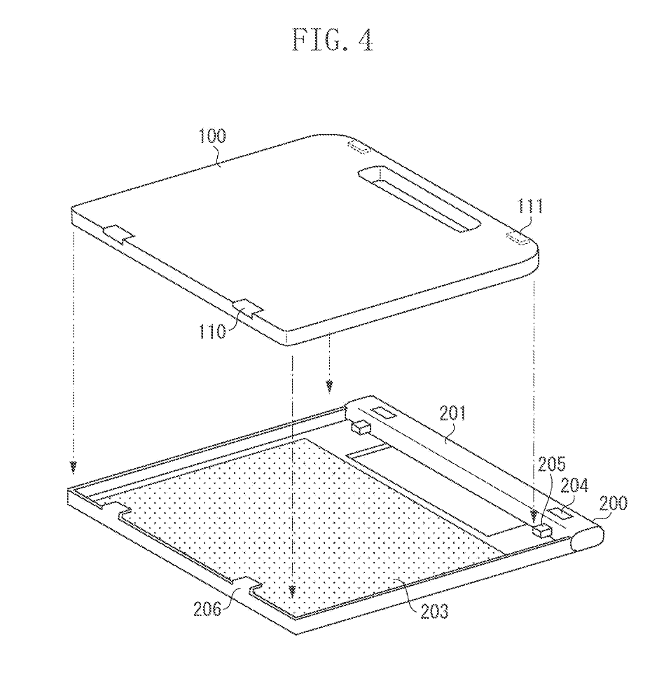

Next, a grid unit 200 according to the present exemplary embodiment will be described with reference to FIGS. 3 and 4. The grid unit 200 includes a frame portion 202 and a grid 203 held by the frame. A lock portion 205 and a claw portion 206 are a combination portion (combining portion) for combining the grid unit 200 with the X-ray detector 100. The frame portion 202 is fixed to outside the X-ray detector 100. Accordingly, the grid 203 is situated in front (on the radiation incident side) of the X-ray detector 100, and thus an image from which scattered radiations are removed can be captured.

The grid 203 generally includes layers of an X-ray shield, such as lead, and an intermediate material that absorbs less X-rays. The grid 203 thus has low mechanical strength. However, the frame portion 202 is made of a metal such as iron to suppress deformation and breakage of the grid 203.

The grid unit 200 includes a gripping portion (second gripping portion) 201. The gripping portion 201 forms a gripping portion together with the gripping portion 101 of the X-ray detector 100 when the X-ray detector 100 is combined with the grid unit 200. This configuration provides improved carrying operability.

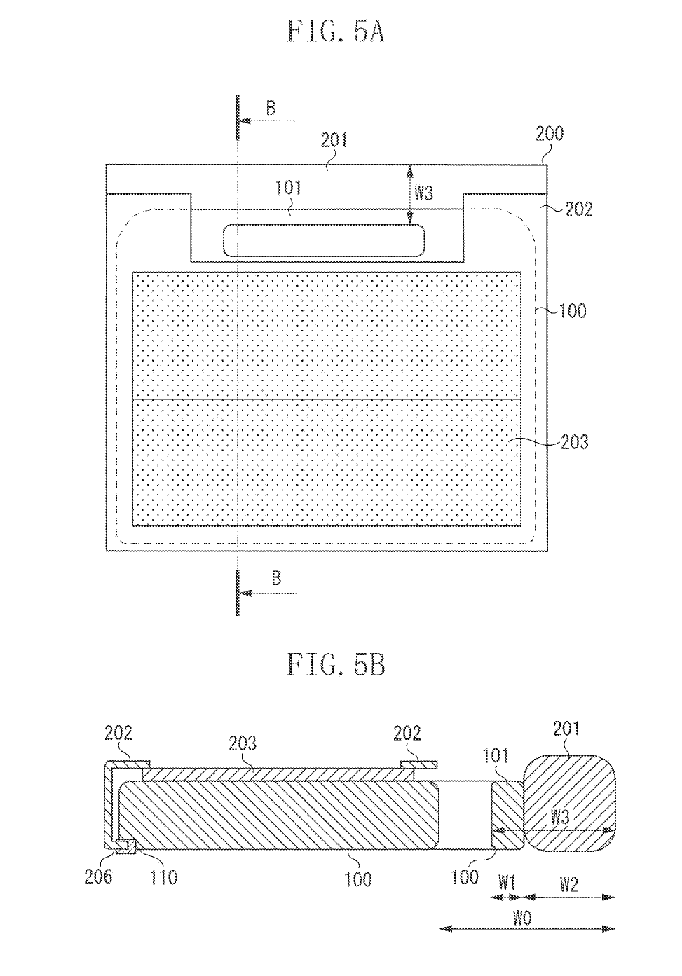

Next, a structure for attaching the grid unit 200 to the X-ray detector 100 will be described with reference to FIGS. 4, 5A, and 5B. FIG. 4 illustrates a method for attaching the grid unit 200 to the X-ray detector 100. FIG. 5A is a front view of the grid unit 200 attached to the X-ray detector 100 as seen from the X-ray incident surface. FIG. 5B is a cross-sectional view taken along the line B-B in FIG. 5A.

In FIG. 4, the bottom and lateral sides of the frame portion 202 of the grid unit 200 are bent to form side walls when the frame portion 202 is manufactured, which provides improved rigidity. The X-ray detector 100 is arranged in a rectangular area formed by the side walls of the frame portion 202 and the gripping portion 201. Gaps between the rectangular area and the X-ray detector 100 can be defined to fix the grid unit 200 to a predetermined position with respect to the X-ray detector 100.

When the grid unit 200 is attached to the X-ray detector 100, the gripping portions 101 and 201 overlap with each other to form a gripping portion that has a width W3. To carry around and use the X-ray detector 100 in a general hospital room or outdoors, the grid unit 200 is attached to and used with the X-ray detector 100 so that imaging is performed with the grid 203 in front of the X-ray detector 100.

When the X-ray detector 100 is loaded into various types of pedestals for imaging, the X-ray detector 100 is not loaded in a state in which the grid unit 200 is attached thereto because pedestals generally include a grid holding mechanism. The width W3 is thus free from size restrictions due to pedestal accommodation, like the width W1 of the gripping portion 101 of the X-ray detector 100. The width W3 can be set to enhanced comfort of gripping while optimizing size and weight of the combined grid and detector. More specifically, the width W3 can be set to 20 to 40 mm for better gripping.

Similarly, the gripping portion 201 of the grid unit 200 is free from size restrictions due to pedestal accommodation. It is preferable that the cross-sectional dimensions of the gripping portion 201 can be made greater than those of the gripping portion 101 of the X-ray detector 100 for better gripping. The gripping portion 201 sometimes undergoes a tilting force like when the operator grips the gripping portion 201 and lifts the grid unit 200 in that horizontal position. In such cases, greater values are desirable for the widths W2 and W3. The widths W2 and W3 can be arbitrarily determined from such conditions.

The gripping portion 201 of the grid unit 200 forms a gripping portion together with the gripping portion 101 of the X-ray detector 100 when the grid unit 200 and the X-ray detector 100 are combined. The gripping portion 201 may be greater than the gripping portion 101. In other words, the gripping portion 101 provided along a side of the casing 102 of the X-ray detector 100 may have a cross section smaller than that of the gripping portion 201, the cross sections being taken along a plane orthogonal to the side. For example, it is preferable to W1≦W2. Both W2 and W3 can be 20 to 40 mm. The size of the cross section of the gripping portion 201 has a particularly high impact when a force to tilt the X-ray detector 100 is applied to the gripping portions 101 and 201.

The force to tilt the X-ray detector 100 refers to a force that is applied in a rotating direction about the axial direction of the gripping portions 101 and 201. The tilting force is proportional to the magnitude of moment about the axial direction of the gripping portions 101 and 201. The gripping portion 201 thus can be made greater to tilt the X-ray detector 100 with a smaller force.

The gripping portion 201 of the grid unit 200 is preferable to be configured to overlap with the side surface of the X-ray detector 100 where the gripping portion 101 lies and not to overlap with the X-ray incident surface side. If the gripping portion 201 is formed to overlap with the X-ray incident surface side, the cross section of the gripping portion 201 will be in roughly L shape which causes uncomfortable feeling when the operator grips the grid unit 200 alone.

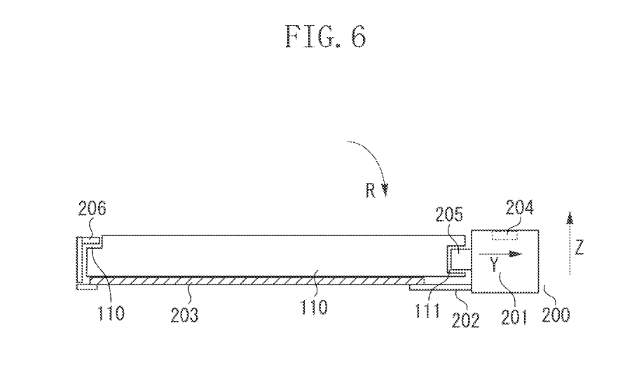

A lock mechanism for combining and releasing the X-ray detector 100 with/from the grid unit 200 will be described with reference to FIG. 6. FIG. 6 is a cross-sectional view of the X-ray detector 100 and the grid unit 200 in an attached state.

The grid unit 200 includes a combination portion including the claw portion (projection portion) 206 and the lock portion (projection portion) 205. The combination portion fits to a recessed portion (recess) 110 and a recessed portion (recess) 111 and is caught by the X-ray detector 100. The grid unit 200 is thus combined with the X-ray detector 100.

The recessed portion 110 is formed in the lower side of the X-ray detector 100. The claw portion 206 is formed on the lower side wall of the grid unit 200 at a position corresponding to the recessed portion 110. The claw portion 206 is caught into the recessed portion 110 to fix the lower side of the grid unit 200 to the X-ray detector 100 in the thickness direction.

Similarly, the recessed portion 111 is formed in the upper side of the X-ray detector 100. The lock portion 205 is formed on the gripping portion 201 of the grid unit 200 at a position corresponding to the recessed portion 111. The lock portion 205 is caught into the recessed portion 111 to fix the upper side of the grid unit 200 to the X-ray detector 100 in the thickness direction.

The lock portion 205 is configured to be capable of being extended and retracted by a switch 204. The switch 204 is used to extend and retract the lock portion (projection portion) 205. The lock portion 205 is integrally formed with a 45 degree tapered member inside the grid unit 200.

When the switch 204 is pressed, the switch 204 itself or a member that moves with the switch 204 in the pressed direction applies a force to the lock portion 205 in a direction opposite to the Z direction. A surface of the lock portion 205 on which the force is applied forms an angle of 45 degrees with respect to the Y direction and the Z direction. A part of the force in the direction opposite to the Z direction is thus converted into a force in the Y direction. As a result, the lock portion 205 is moved into the interior of the grid unit 200 (the Y direction in FIG. 6).

In such a manner, the lock portion 205 is moved back in the Y direction in FIG. 6 and retracted into the gripping portion 201 when the user presses the switch 204. The lock portion 205 is protruded when the switch 204 is not pressed.

To attach the grid unit 200 to the X-ray detector 100, the user moves the X-ray detector 100 in the R direction in FIG. 6 while pressing the switch 204. The user then releases the switch 204, so that the lock portion 205 fits into the recessed portion (recess) 111 of the X-ray detector 100. The X-ray detector 100 is caught on the lock portion 205, thus the X-ray detector 100 is combined with the grid unit 200.

As described above, the grid unit 200 can be attached to the X-ray detector 100 by putting the lower claw portion 206 into engagement and then operating the switch 204 to engage the lock portion 205 with the grid unit 200 and the X-ray detector 100 stacked. According to such a configuration, the grid unit 200 can be easily attached and detached to/from the X-ray detector 100.

Since the grid unit 200 and the X-ray detector 100 are fixed by the lock portion 205, the grid unit 200 and the X-ray detector 100 each are prevented from an accidental drop by itself. In addition, since the lock portion 205 is located near the gripping portion, the user can handle the X-ray detector 100 and the grid unit 200 without a shift in the thickness direction. The shift-suppressing effect functions particularly desirably when the gripping portion undergoes a force to tilt the X-ray detector 100.

As illustrated in FIG. 6, the lock portion 205 is accommodated in the gripping portion 201, and the lock mechanism for interlocking protrusion and retraction of the lock portion 205 and the operation of the switch 204 is built in the gripping portion 201. Such a configuration avoids an increase in size.

There is a plurality of grids with different characteristics including grid densities, focusing distances, grid ratios, and the like. A grid having appropriate characteristics needs to be selected according to an imaging target and diagnostic use. Easy attachment, detachment, and replacement of grids are therefore highly important. According to the present exemplary embodiment, the grid unit 200 can be easily attached and detached by using the switch 204. An appropriate grid unit 200 can thus be easily selected and used according to imaging purposes from among a plurality of grid units 200.

According to the above described configuration, it is possible to provide an X-ray imaging apparatus including an X-ray detector 100 whose grip portion 101 is restricted in terms of width, and more specifically, that is used by being mounted on a pedestal, and that provides high carrying operability when a grid is attached thereto. The X-ray detector 100 can provide a wide imaging area when being mounted on a pedestal. The X-ray detector 100 also has an advantage of small size and high usability when used for imaging without being mounted on the pedestal and without using a grid.

Now, suppose that the X-ray detector 100 is used for imaging without being mounted on a pedestal but with a grid. Examples include when the X-ray detector 100 is carried around and used for imaging in a general hospital ward or outdoors. In such cases, the direct attachment of the grid to the X-ray detector 100 increases the total weight and, if the gripping portion 101 is thin, inevitably degrades operability. In addition, the high frequency of movement requires high operability. The grid unit 200 of the present exemplary embodiment can be used to compensate for the weight increase due to the grid, and can provide improved portability and operability. The grid unit 200 is particularly useful when the user makes a tilting operation while gripping the gripping portion.

An X-ray detector 100 according to a another exemplary embodiment of the present invention will be described below. More specifically, the configuration of an X-ray detector 100 that can be accommodated in various types of conventional pedestals and whose X-ray reading center can be aligned to the center of a pedestal by a similar method as with a conventional film cassette is described as follows.

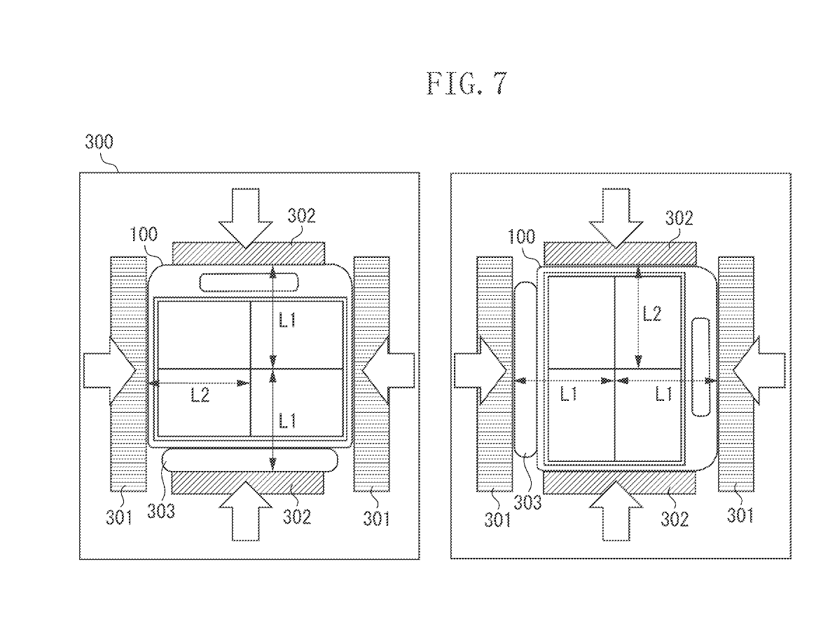

FIG. 7 illustrates use modes when the X-ray detector 100 is loaded into an accommodation unit 300 of a pedestal like an imaging stand. The accommodation unit 300 includes two positioning mechanisms 301 that can be moved in a lateral direction in FIG. 7. The two positioning mechanisms 301 move in association with each other. The accommodation unit 300 also includes positioning mechanisms 302 that can be moved in a vertical direction in FIG. 7.

The accommodation unit 300 is generally designed to a standard size of a conventional film cassette (384×460 mm) with a 14×17-inch effective image area. A film cassette may be loaded by rotating 90 degrees. The positioning mechanisms 301 and 302 thus form a square mounting area with the maximum outer dimensions of 460 mm on a side. The positioning mechanisms 301 and 302 are moved to form a mounting area corresponding to an imaging apparatus to mount. By moving the positioning mechanisms, an imaging apparatus including vertically and horizontally symmetrical shape like a conventional film cassette can match the center of the accommodation unit 300 and the center of the accommodated imaging unit.

The X-ray detector 100 including the gripping portion 101 can also be aligned to the center by the similar positioning mechanisms, using the following configuration. Suppose that the outermost distance from the center of the X-ray reading area of the X-ray detector 100 to the gripping portion 101 is a length L1, and the distance from the center of the X-ray reading area to either side of the X-ray detector 100 orthogonal to the side having the gripping portion 101 is a length L2.

The X-ray detector 100 is configured to have dimensions such that the outermost distance from the center of the X-ray reading area (i.e., an imaging area) to the side having the gripping portion 101 is shorter than or equal to the distance from the center of the X-ray reading area to either side orthogonal to the side having the gripping portion 101. In other words, the X-ray detector 100 is formed so that the length L1 and the length L2 satisfy the relationship L1≦L2.

More specifically, the length L2 is designed to be approximately 230 mm (=460×½) in consideration of the standard size of a conventional film cassette. The length L1 is designed to be smaller than or equal to ½ the maximum outer dimension of the positioning mechanisms 301 and 302 (approximately 230 mm or less). A spacer 303 is arranged on the side opposite from the gripping portion 101 so that the outermost distance from the center of the X-ray reading area to the spacer 303 is the length L1. Consequently, the center of the X-ray reading area of the X-ray detector 100 can be aligned to the center of the accommodation unit 300 by the accommodation unit 300 for a conventional film cassette.

Since the above-described X-ray detector 100 has the size restriction of the length L1, the width W1 of the gripping portion 101 is difficult to increase. More specifically, the width W0 across the opening 112 and the gripping portion 101 needs to be 40 mm or less. As described in the first exemplary embodiment, if the opening 112 has too small a width to put fingers through with protective gloves on, the user cannot carry the X-ray detector 100 by gripping the gripping portion 101. The opening 112 therefore needs to have a width of around 30 mm, and the width W1 needs to be 10 mm or less. Accordingly, the present exemplary embodiment of the present invention can be suitably applied to realize an X-ray imaging apparatus that provides high operability when carried around with a grid attached.

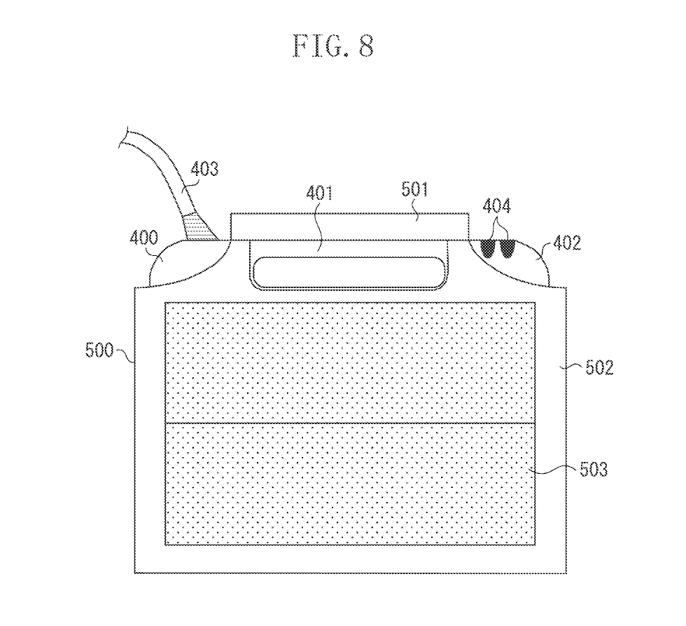

Next, a configuration of another exemplary embodiment in which a grid unit 500 is attached to an X-ray detector 400 will be described with reference to FIG. 8. The X-ray detector 400 includes a connection portion of a cable 403 which provides power supply to and transmits and receives a signal to/from the X-ray detector 400, and display units 404 which display a state of the X-ray detector 400. The connection portion and the display units 404 are arranged on the side of the X-ray detector 400 where a gripping portion 401 lies. When the grid unit 500 is attached to the X-ray detector 400, a gripping portion 501 of the grid unit 500 is located between the connection portion of the cable 403 and the display units 404.

The X-ray detector 400 is connected with the cable 403 which is used for providing power supply and perform communication with an external control unit. There have been developed cableless configurations using wireless technologies and battery technologies. Thus, X-ray detectors like the one described in the first exemplary embodiment have been made possible. However, cabled configurations may be preferred depending on the necessity of battery charging and the wireless environment in the imaging location. The cable 403 is connected to the side including the gripping portion 401. The gripping portion 501 of the grid unit 500 is shaped to place a distance from the cable 403. Such a shape allows the attachment and detachment of the grid unit 500 with the cable 403 connected.

The X-ray detector 400 includes the display units 404 for notifying the user of the state of the X-ray detector 400 including an imaging state and a power supply state. The display units 404 allow the operator to check the state of the X-ray detector 400 and avoid operation errors. To prevent the display units 404 from becoming invisible to the user when the grid unit 500 is attached, the gripping portion 501 and a frame portion 502 are configured to place a distance from the display units 404.

More specifically, the grid unit 500 is shaped so that the display units 404 are not covered by the grid unit 500 but exposed at least in part when the grid unit 500 is combined with the X-ray detector 400. The display units 404 of the X-ray detector 400 are also arranged in consideration of the shape of the grid unit 500. There are a lot of components including analog circuits, drive circuits, and the like near the imaging area. The display units 404 are therefore arranged by using the space inside the gripping portion 401. In particular, the display units 404 can be located adjacent to the opening of the gripping portion 401 by utilizing the fact that the grid unit 500 has an opening greater than that of the X-ray detector 400. This configuration makes effective use of the internal space of the casing to contribute to miniaturization of the X-ray detector 400 in consideration of restrictions of the digital X-ray detector 400.

According to the above-described configuration, the X-ray detector 400 including the cable 403 and the display units 404 can also be used for gridded imaging while using the cable 403 and the display units 404.

According to the above exemplary embodiments, a digital X-ray detector and a grid unit are described. However, the techniques described in the above exemplary embodiments are not limited to X-rays and may be applied to detectors that detect other radiations to obtain a radiation image, including alpha rays, beta rays, and gamma rays. In such cases, radiation sensors appropriate for the radiations to be detected are used instead of an X-ray sensor.

The exemplary embodiments are described with emphasis on size restrictions on the gripping portion of an X-ray detector due to pedestal mounting. However, the techniques described in the above exemplary embodiments are not limited thereto and may be applied when the performance of the gripping portion needs to be minimized to meet a demand for miniaturization of an X-ray detector.

Certain aspects of the present invention can be realized by a computer of a system or apparatus (or devices such as a CPU or an MPU) that reads out and executes a program recorded on a memory device to perform the functions described in the exemplary embodiments. Operation steps, for example, reading out and executing a program recorded on a memory device to perform the functions of the above-described embodiments may be performed by a computer of a system or apparatus. For example, the image processing unit 4, which applies predetermined image processing to an X-ray image that is based on electronic signals, can be implemented as described above. For this purpose, the program is provided to the computer for example via a network or from a recording medium of various types serving as the memory device (e.g., computer-readable medium).

While the embodiments has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-211127 filed Sep. 27, 2011, which is hereby incorporated by reference herein in its entirety.

What is claimed is:

1. A radiation imaging apparatus comprising:
a radiation detector configured to be mountable on a pedestal for a grid to be inserted into; and
a grid unit configured to be used with the radiation detector not mounted on the pedestal,
wherein the radiation detector includes:
a radiation sensor configured to convert incident radiation into an electrical signal to obtain an image,
a casing configured to accommodate the radiation sensor, and
a first gripping portion formed on the casing,
wherein the grid unit includes
a grid,
a combining portion configured to combine the grid unit with the radiation detector, and
a second gripping portion configured to form a gripping portion together with the first gripping portion of the radiation detector in a state where the grid unit is combined with the radiation detector.

2. The radiation imaging apparatus according to claim 1, wherein the first gripping portion of the radiation detector is arranged along a side of the casing, and
wherein a cross-section of the second gripping portion taken along a plane orthogonal to the side is greater than a cross-section of the first gripping portion taken along the plane.

3. The radiation imaging apparatus according to claim 1, wherein the second gripping portion of the grid unit is configured to overlap with a side surface of the radiation detector on which the first gripping portion is provided, and not to overlap with a radiation-incident surface side of the first gripping portion of the radiation detector in a state where the grid unit is attached to the radiation detector.

4. The radiation imaging apparatus according to claim 1, wherein the combining portion of the gird unit includes a projection portion, and the projection portion is configured to engage with a recessed portion of the radiation detector, so that the grid unit and the radiation detector are combined.

5. The radiation imaging apparatus according to claim 4, further comprising a lock mechanism configured to protrude or retract at least a part of the projection portion.

6. The radiation imaging apparatus according to claim 5, wherein the projection portion is configured retract into the second gripping portion of the grid unit, and the lock mechanism is built in the second gripping portion.

7. The radiation imaging apparatus according to claim 1, wherein the radiation detector is configured so that an outermost distance from a center of an X-ray reading area to the side including the first gripping portion is equal to or shorter than a distance from the center of the X-ray reading area to either side orthogonal to the side including the first gripping portion.

8. The radiation imaging apparatus according to claim 1, wherein the radiation detector further includes a display unit configured to notify a state of the radiation detector, and
wherein the display unit is not to be covered by the grid unit but exposed at least in part in the state where the radiation detector and the grid unit are combined.

9. The radiation imaging apparatus according to claim 8, wherein the display unit is located adjacent to an opening of the first gripping portion of the radiation detector.

10. The radiation imaging apparatus according to claim 1, wherein a cable connection portion and a display unit are arranged on the side of the radiation detector on which the first gripping portion is provided, the cable connection portion being configured to provide power supply to and transmit and receive a signal to/from the radiation detector, the display unit being configured to display a state of the radiation detector, and
wherein the second gripping portion of the grid unit is configured to be located between the connection portion and the display unit in a state in which the grid unit is attached to the radiation detector.

11. The radiation imaging apparatus according to claim 1, wherein an opening of the second gripping portion of the grid unit is of larger size than an opening of the first gripping portion of the radiation detector.

12. The radiation imaging apparatus according to claim 1, wherein the grid unit further includes a frame portion configured to hold the grid.

13. The radiation imaging apparatus according to claim 1, wherein the grid unit is configured to be attached to cover a surface of the casing of the radiation detector for a radiation to be incident on.

14. A radiation imaging apparatus comprising:
a radiation detector; and
a grid unit configured to be detachably assembled with the radiation detector,
wherein the radiation detector includes:
a radiation sensor configured to convert an incident radiation into an electrical signal to obtain an image based on the incident radiation,
a casing configured to accommodate the radiation sensor, and
a first gripping portion formed on the casing, and
wherein the grid unit includes:
a grid,
a combining portion configured to combine the grid unit with the radiation detector, and
a second gripping portion configured to form a gripping portion together with the first gripping portion of the radiation detector in a state where the grid unit is detachably assembled with the radiation detector, the second gripping portion having a size greater than or equal to a size of the first gripping portion.

15. The radiation imaging apparatus according to claim 1, further comprising
a pedestal configured for the radiation detector to be mounted on,
wherein the pedestal includes:
a detector holding unit configured to hold the radiation detector, and
a grid holding unit configured to hold the grid.

16. The radiation imaging apparatus according to claim 1, wherein the second gripping portion has a size greater than or equal to a size of the first gripping portion.

17. A grid unit configured to be attached to a radiation detector, the grid unit comprising:
a grid;
a frame portion configured to hold the grid;
a combining portion configured to combine the grid unit with the radiation detector; and
a second gripping portion configured to form a gripping portion together with the first gripping portion of the radiation detector in a state where the grid unit is combined with the radiation detector, and have a size greater than or equal to that of the first gripping portion.

18. The grid unit according to claim 17, wherein the first gripping portion of the radiation detector is arranged along a side of a casing of the radiation detector, and
wherein a cross-section of the second gripping portion taken along a plane orthogonal to the side is greater than a cross-section of the first gripping portion taken along the plane.

19. A grid unit configured to be combined with a radiation detector having a first gripping portion, the grid unit comprising:
a grid configured to be arranged on a radiation incident surface side of the radiation detector;
a frame portion configured to hold the grid;
a combining portion configured to combine the grid unit with the radiation detector, and
a gripping portion configured to form a second gripping portion together with the first gripping portion of the radiation detector in a state where the grid unit is combined with the radiation detector.
